(19) United States
(12) Patent Application Publication
(10) Pub. No.: US 2022/0398630 A1
(43) Pub. Date: Dec. 15, 2022

(54) SERVICE PROVIDER MARKETING SYSTEM

(71) Applicant: Charles Isgar, Scottsdale, AZ (US)

(72) Inventor: Charles Isgar, Scottsdale, AZ (US)

(21) Appl. No.: 17/839,642

(22) Filed: Jun. 14, 2022

Related U.S. Application Data
(60) Provisional application No. 63/210,147, filed on Jun. 14, 2021.

(51) Int. Cl. G06Q 30/02; G06Q 30/06

(52) U.S. Cl. CPC G06Q 30/0261; G06Q 30/0205; G06Q 30/0623; G06Q 30/0639

(57) ABSTRACT

Described is a service provider marketing system for use to market services provided in various areas and locations. The system allows services provides to enter locations of services provided for viewing by those seeking for such services. The users seeking service may then based on the location entered by the user, view service providers who provide services within the area of the entered location, such as the users neighborhood. This allows the user to identify the properties for which the services are being rendered and see who is most popular with neighbors or see the provider of services that the user has identified as pleasing or liking. The system then provides information for the user to contact the service provider.

### CROSS REFERENCE TO RELATED APPLICATION[S]

This application claims priority to U.S. Provisional Patent Application Ser. No. 63/210,147, filed Jun. 14, 2021, the disclosure of which is hereby incorporated entirely herein by reference.

### BACKGROUND OF THE INVENTION

### Technical Field

This invention generally relates to a system for marketing services provided to homes, and more specifically to a marketing system for service providers to easily identify homes/properties they provide services to and allows users seeking service to easily identify the services providers for homes in their neighborhood.

### State of the Art

There is a common need for service providers for homes, apartments and the like for such services like lawn care, dog walking, pool cleaning, house cleaning, house painting, and so forth. In many instances, individuals providing such services, may be teenagers, neighborhood residence or the like that lack the means to advertise to other neighbors. It is common for individuals to see homes within a neighborhood and wonder who cares for their lawn, who painted their house and so forth. There is not a system that allows an individual to obtain such information easily and without knocking on the neighbor's door and asking. Their lacks a system where service providers can easily identify the homes that they provide services for and allow the system to provide a means for other new clients/residents of the neighborhood to contact them and engage them to provide services. The informal economy needs a simple connection application that only requires the matching of a service address and contact information of a service provider, such system does not exist today to serve this more causal service provider connection.

Accordingly, what is needed is a marketing system for service providers to easily identify homes/properties to which they provide services and for individuals seeking service to easily identify the services providers for other homes/properties in their neighborhood.

### SUMMARY OF THE INVENTION

An embodiment includes a service provider marketing system comprising: a server having a memory storing service provider information; a provider computing device coupled to the server; and a user computing device coupled to the server, wherein the server is programmed to: receive and process a signal that the provider computing device has accessed the system for entering service provider information; receive and store first service provider information sent from the user computing device in the memory of the server, wherein the first service provider information includes one or more service addresses, a first service category, and contact information for the first service provider; receive and process a signal that the user computing device has accessed the system and is searching for service providers; automatically send, for display, a user interface comprising selectable service categories, including the first service category; receive and process a selection of the first service category from the user computing device; automatically send, for display on the user computing device, a user interface comprising input of an address of a first service location that the user likes corresponding the first service category; receive and process the first service location information sent from the user computing device, wherein the first service location information corresponds to the first service provider information; and automatically send, for display on the user computing device, a user interface comprising the first service provider.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a service provider marketing system according to an embodiment;

FIG. 2A is a user interface on a provider computing device for interaction with a service provider marketing system to enter service addresses with text according to an embodiment;

FIG. 2B is a user interface on a provider computing device for interaction with a service provider marketing system to enter service addresses with a map according to an embodiment;

FIG. 3 is a user interface on a provider computing device for interaction with a service provider marketing system to enter services provided according to an embodiment;

FIG. 4 is a user interface on a provider computing device for interaction with a service provider marketing system to enter provider contact information according to an embodiment;

FIG. 5 is a user interface on a user computing device for interaction with a service provider marketing system to select a service category according to an embodiment;

FIG. 6 is a user interface on a user computing device for interaction with a service provider marketing system to enter an address according to an embodiment;

FIG. 7 is a user interface on a user computing device for interaction with a service provider marketing system to view a service provider associated with the service address according to an embodiment;

FIG. 8A is a user interface on a user computing device for interaction with a service provider marketing system to view all homes within a neighborhood serviced by the service provider according to an embodiment;

FIG. 8B is a user interface on a user computing device for interaction with a service provider marketing system to view all service providers and corresponding homes within a neighborhood according to an embodiment.

FIG. 9 is a user interface on a user computing device for interaction with a service provider marketing system to view service provider information corresponding to selection of one of the homes displayed in FIG. 8B according to an embodiment;

FIG. 10 is a user interface on a user computing device for interaction with a service provider marketing system to display contact information of a service provider according to an embodiment;

FIG. 11 is a user interface on a user computing device for interaction with a service provider marketing system to select multiple services according to an embodiment; and

FIG. 12 is a user interface on a user computing device for interaction with a service provider marketing system to view homes within a neighborhood receiving services selected according to an embodiment.

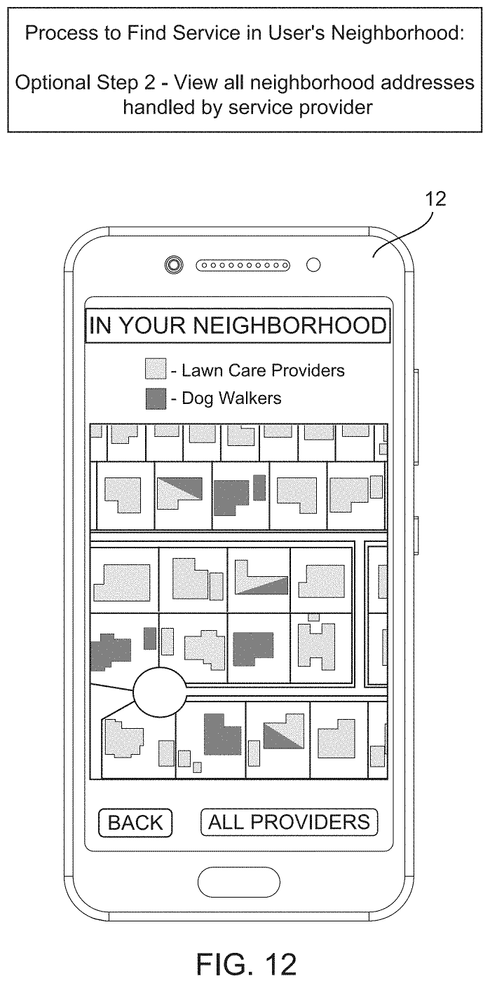

### DETAILED DESCRIPTION OF EMBODIMENTS OF THE INVENTION

Embodiments of the present invention relate to a service provider marketing system for marketing services by a provider to others within an area of other locations the service provider has and/or continues to work. Modern technology utilized by the system operates as a new and efficient bartering and borrowing system. The system may include the use of a mobile application operating on a user computing device and a provider computing device, either or both of which may be a mobile computing device like a smartphone, a tablet, a wearable, and the like; and/or the system may operate on any type of computing device as a downloadable application or even as a web application.

Operations of the system 10 provide various benefits. For example, the system includes a simple, sign up (just give a phone number and address and identify service), providers can market their services that are house by house in a neighborhood, GPS identifies in layers who is doing what in your neighborhood, no ratings or interaction necessary beyond just a map of who is doing what, is a natural advertising is that your neighbors have picked and tested them, can be an extension to a bigger neighborhood app, can be linked to payment systems, such as, but not limited to Venmo, or can make monthly payments for ongoing services.

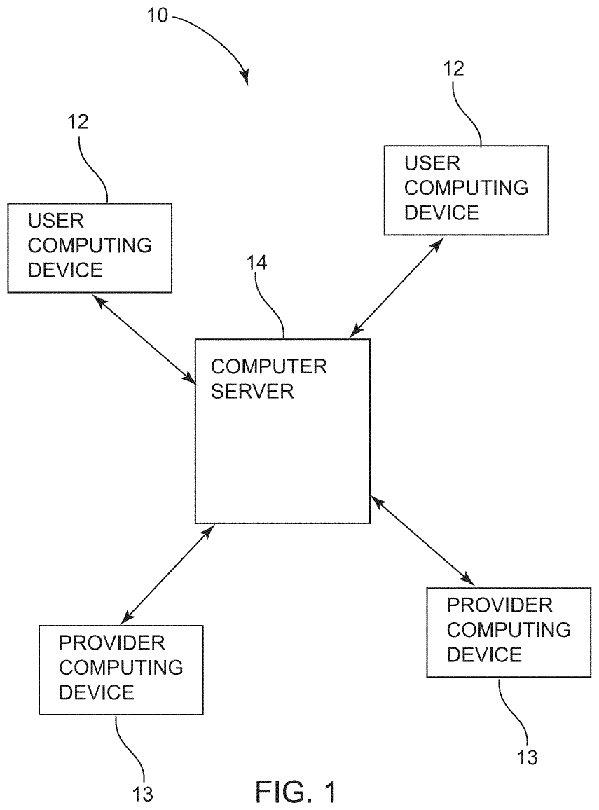

FIG. 1 depicts an embodiment of a service provider marketing system 10. The system 10 may include user computing devices 12, provider computing devices 13 and a server 14, wherein each user computing device 12 and provider computing device 13 is coupled to the computer server 14. This coupling may be a network connection, such as a wireless connection through an Internet connection, a Wi-Fi connection, a Bluetooth connection or the like, wherein the user computing devices 12 and provider computing devices 13 may communicate with and receive communication from the server 14. The user computing device 12 and/or the provider computing devices 13 may be any of a desktop computer, a laptop, a tablet, a smartphone, wearable devices and the like. The server 14, in some embodiments, may be a computer server or a cloud-based infrastructure architecture.

The server 14 may include a memory storing service provider information. The service provider information may include address or location information of a property the service provider has and/or continues to render services, a name of the service provider, contact information of the service provider, such as a phone number, and possibly payment credentials for receiving payment for services rendered, and the like.

A user computing device 12 and a provider computing device 13 may each be coupled to the server 14. The server 14 may be programmed to receive and process a signal that the provider computing device has accessed the system for entering service provider information; receive and store first service provider information sent from the user computing device in the memory of the server, wherein the first service provider information includes one or more service addresses, a first service category, and contact information for the first service provider; receive and process a signal that the user computing device has accessed the system and is searching for service providers; automatically send, for display, a user interface comprising selectable service categories, including the first service category; receive and process a selection of the first service category from the user computing device; automatically send, for display on the user computing device, a user interface comprising input of an address of a first service location that the user likes corresponding the first service category; receive and process the first service location information sent from the user computing device, wherein the first service location information corresponds to the first service provider information; and automatically send, for display on the user computing device, a user interface comprising the first service provider.

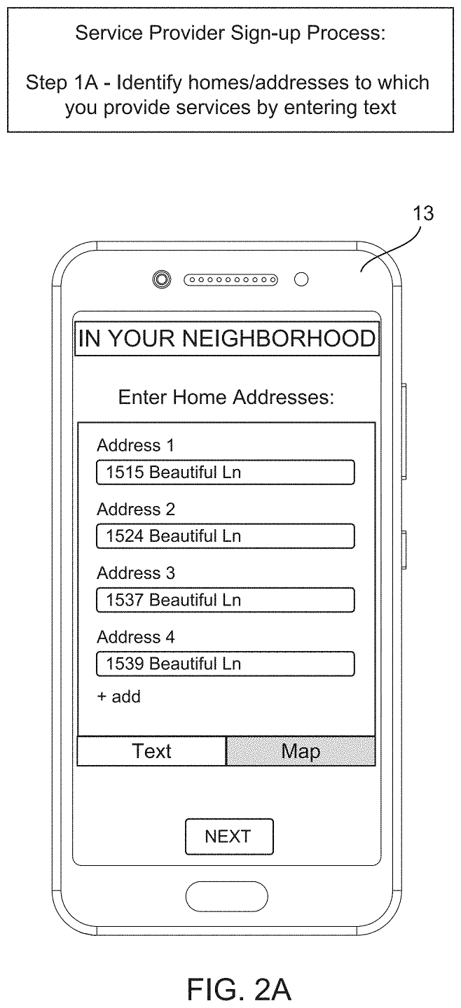

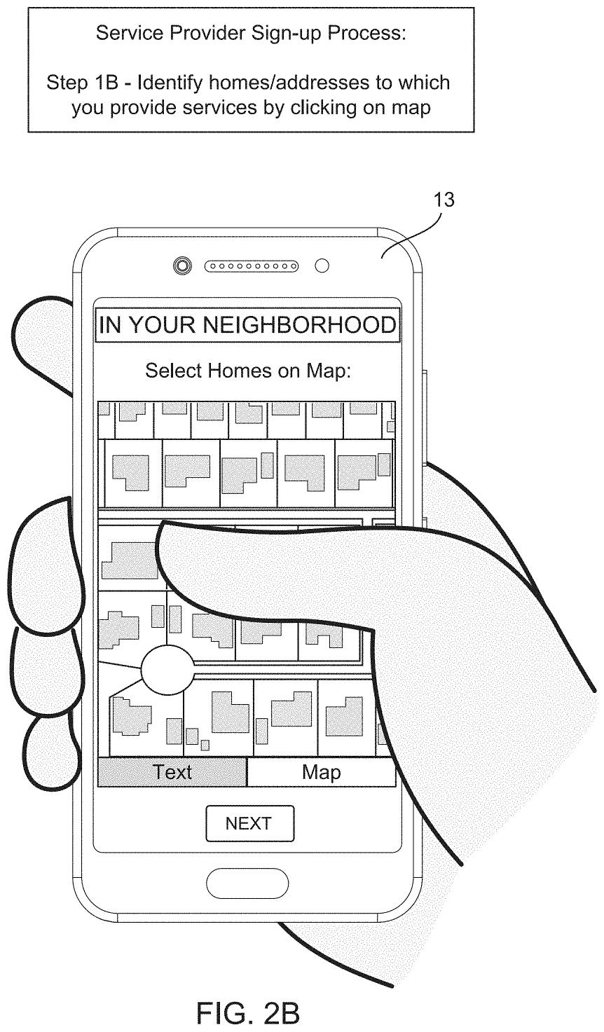

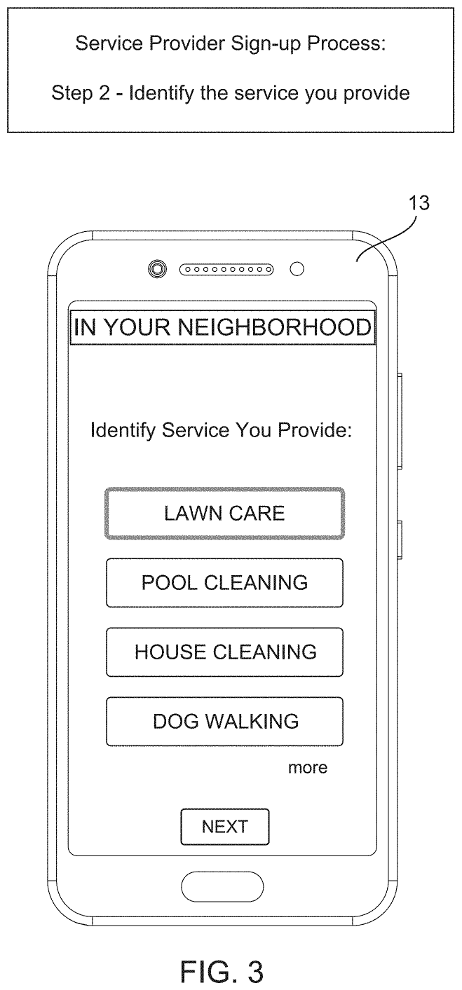

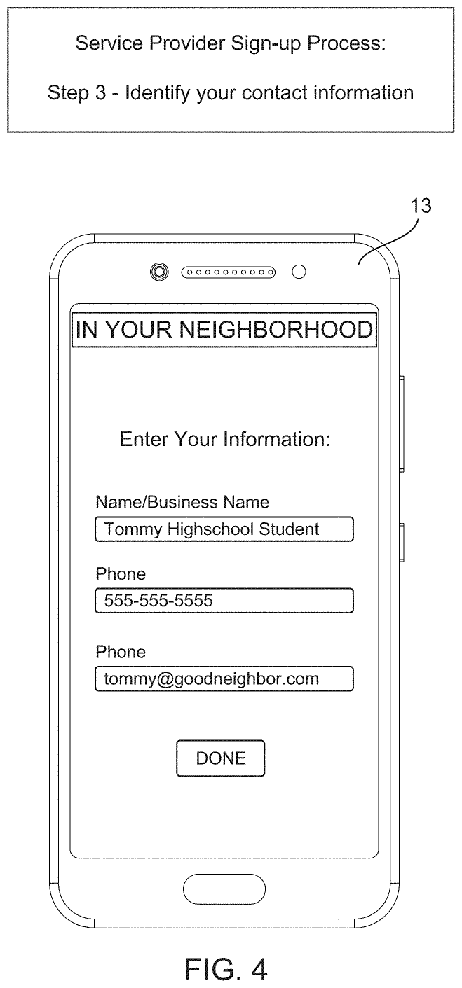

Referring to FIGS. 2A-4, the system 10 may then allow a provider to access the system 10 through the provider computing device 13. This may be done through a mobile phone, a tablet, a computer or the like and interact with the system through a website, a web app, an application or the like. As shown in the figures, a mobile app operating on a smart phone may connect a provider computing device 13 with the server 14. The operation of the provider computing device 13 may include a user interface to gather information from the service provider, for example in three steps. For example, a Step 1 of identifying homes/addresses to which the service provider provides services may be accomplished in one of two ways. One way is through entering the information using text entry boxes displayed on the provider computing device 13 as depicted in FIG. 2A. Another way is through selecting the homes/addresses using a map interface displayed on the provider computing device 13 as depicted in FIG. 2B. The provider computing device 13 may display, once the addresses are entered, a user interface for having selectable service categories, as shown in FIG. 3, leading to Step 2 of identifying the services the service provider provides. The selectable categories, may include, without limitation, lawn care, pool cleaning, house cleaning, dog walking, pest control, car rides to school, home repair, plumbing, HVAC services, and the like. The service provider may select one of the service categories, such as lawn care, as depicted in FIG. 3. Once the service category is selected, the service provider may be directed to Step 3 of identifying the service provider contact information, wherein the provider computing device 13 will then have displayed, as provided by the server 14, a user interface for entering service provider contact information, as shown in FIG. 4. The contact information of the service provider may include the name of the service provider, a phone number and/or an email address. The server 14 is programmed to store this service provider information for later recall and sending to a user computing device 12 and the like that engages with the system 10. The service provider may use the provider computing device 13 to enter service provider information for all locations that services have been or continue to be provided. The service provider information stored in the memory of the server 14 is accessible by other in the system, such as, for example, other users of the system 10.

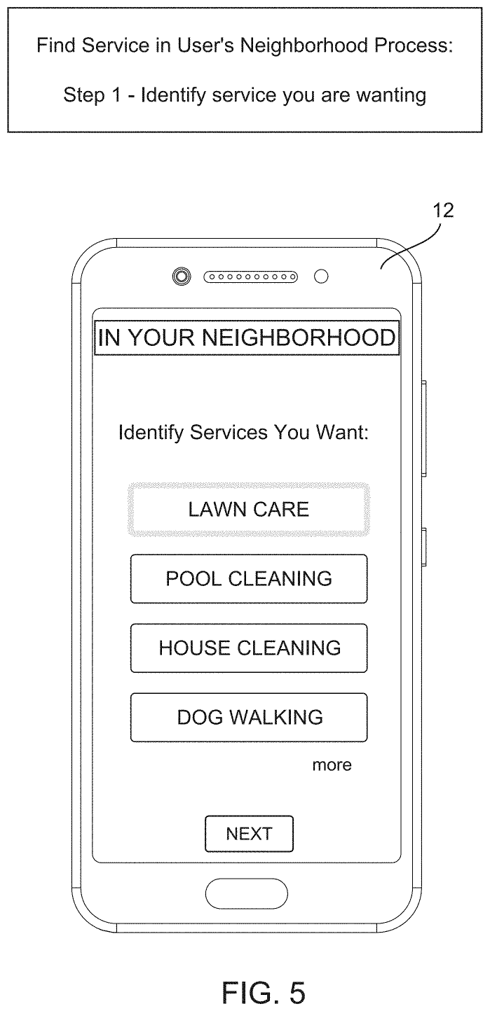

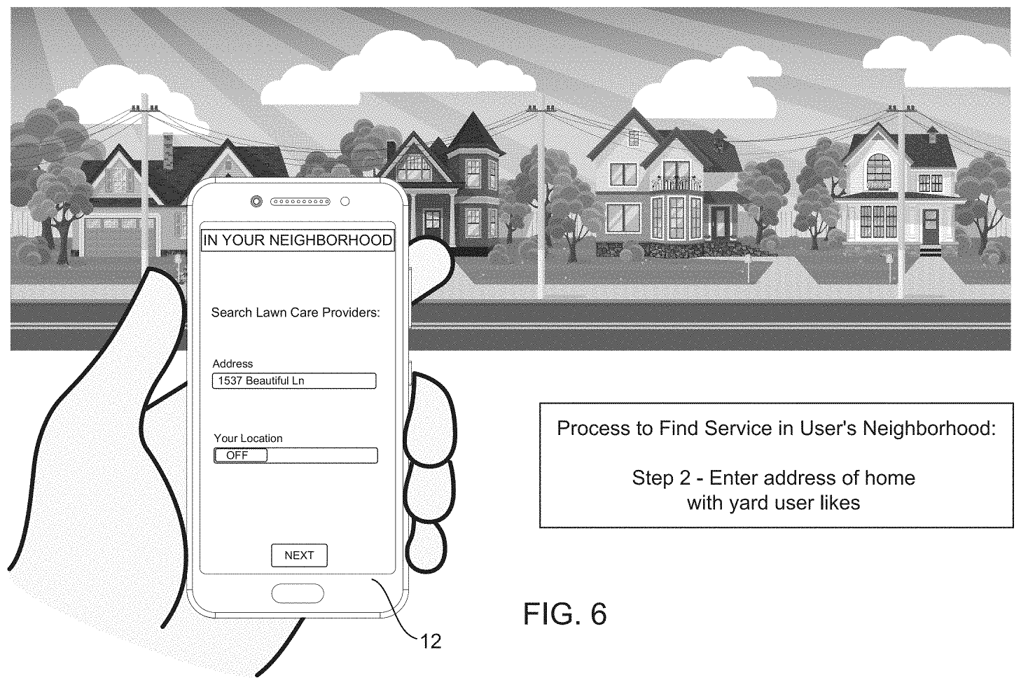

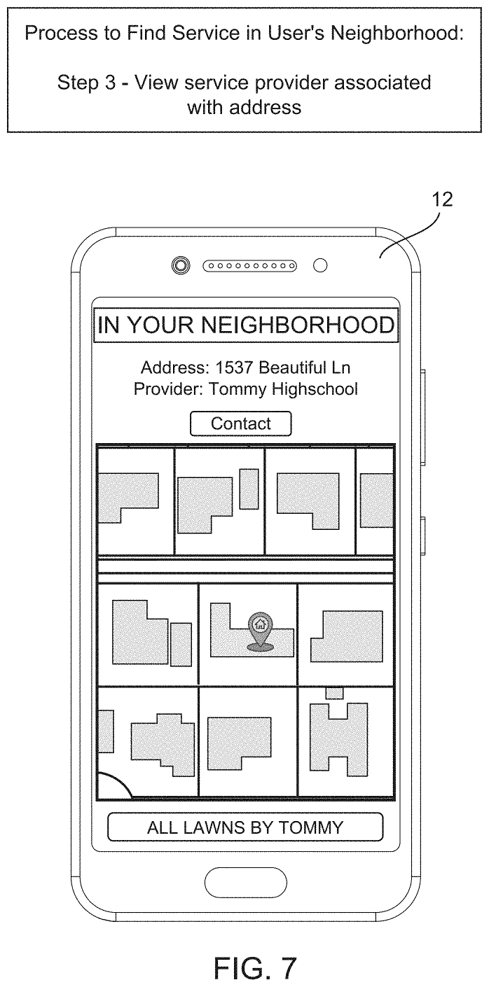

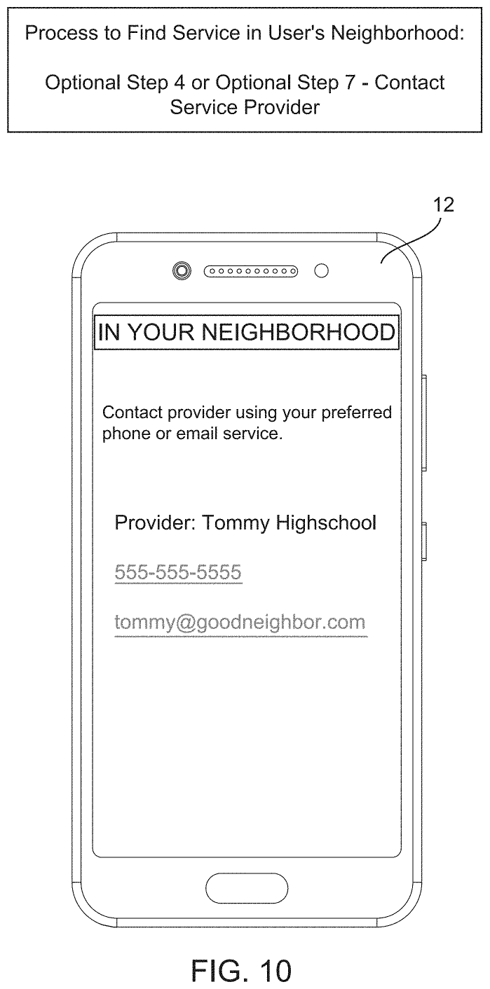

A user seeking for a service provider may engage the system 10 through use of a user computing device 12 as depicted in FIGS. 5-10. For example, and without limitation, the user computing device 12 may access the system 10 through a network connection such as through a mobile app operating on a smart phone may connect a user computing device 12 with the server 14. For example, Step 1 for a user may include identifying the services wanted, such as shown in FIG. 5 that depicts a user interface having selectable service categories. The selectable categories, may include, without limitation, lawn care, pool cleaning, house cleaning, dog walking, pest control, car rides to school, home repair, plumbing, HVAC services, and the like. The user may select one of the service categories, such as lawn care, as depicted in FIG. 5. The user computing device 12 will then have displayed, as provided by the server 14, a user interface with text entry or GPS entry of an address associated with the service category selected, leading the user to Step 2 of entering address of the home the user identifies as a good work associated with the service category selected. Entry of the address and sending to the server 14, results in the server 14 sending for display a user interface that may include a map designating the home/property corresponding to the entered address and the service provider information associated with the home/property address entered, leading the user to Step 3 of view the service provider associated with the address. The user may select to contact the service provider and be directed to a user interface to view the contact information associated with the service provider as shown in FIG. 10, wherein the user may engage in Step 4 of contacting the service provider using the users preferred phone or email service.

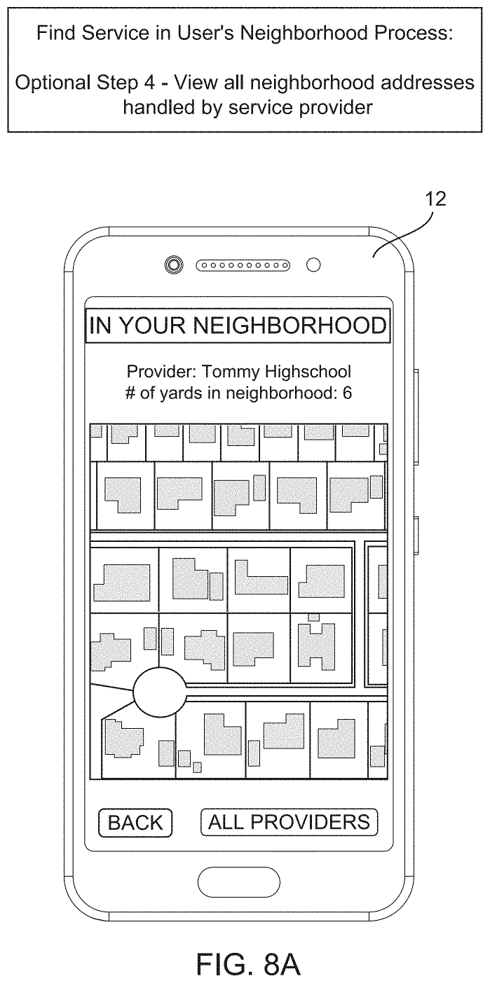

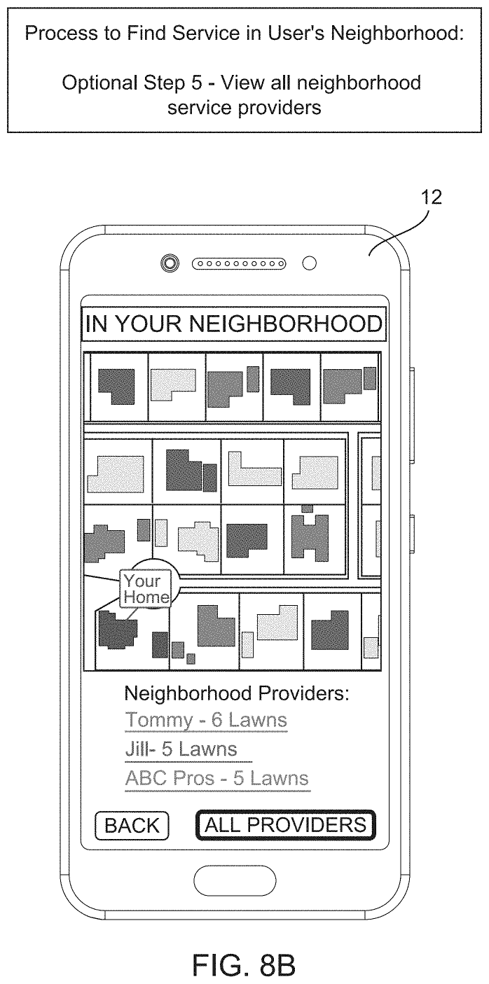

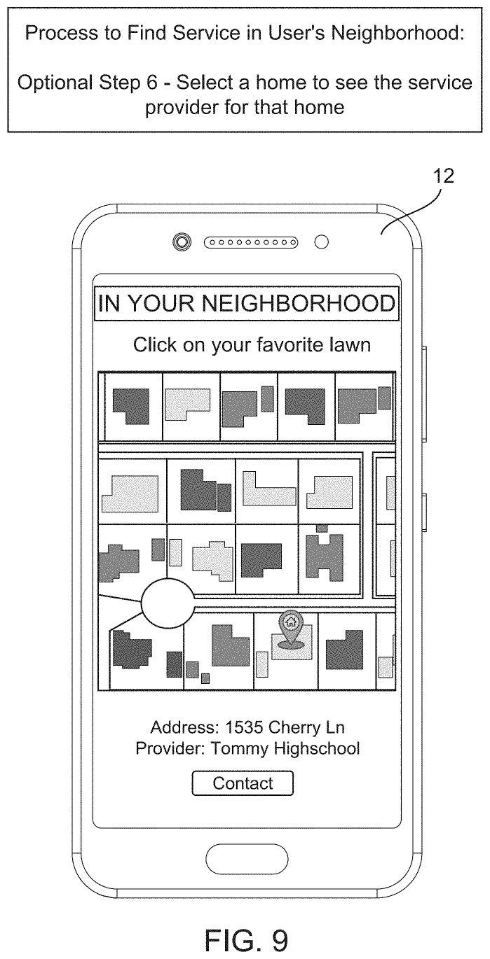

There may be additional interactions with the system 10 by the user computing device. For example, the user may engage in Optional Step 4 to view all neighborhood address handled by the service provider returned in the search performed in FIGS. 5-7 by selecting to view all address by the service provider. The server 14 may then send for display on the user computing device a map designating all homes/addresses the service provider is actively providing services for, as shown in FIG. 8A. The user may proceed to Optional Step 5 and select to view all neighborhood service providers associated with the selected service category. All of the providers may then be displayed in on the user computing device 12 as sent by the server 14, with differentiated indentifiers between service providers, such as by color, and may further include a number of homes/addresses serviced by each of the service providers, as depicted in FIG. 8B. The user may then operate user computing device 12 to initiate Optional Step 6 of selecting a home/address to see the service provider for that home/address, as shown in FIG. 9. This selection brings up the address of the home and the service provider's name. The user may select to contact the service provider and be directed to a user interface to view the contact information associated with the service provider as shown in FIG. 10, wherein the user may engage in Optional Step 7 of contacting the service provider using the users preferred phone or email service.

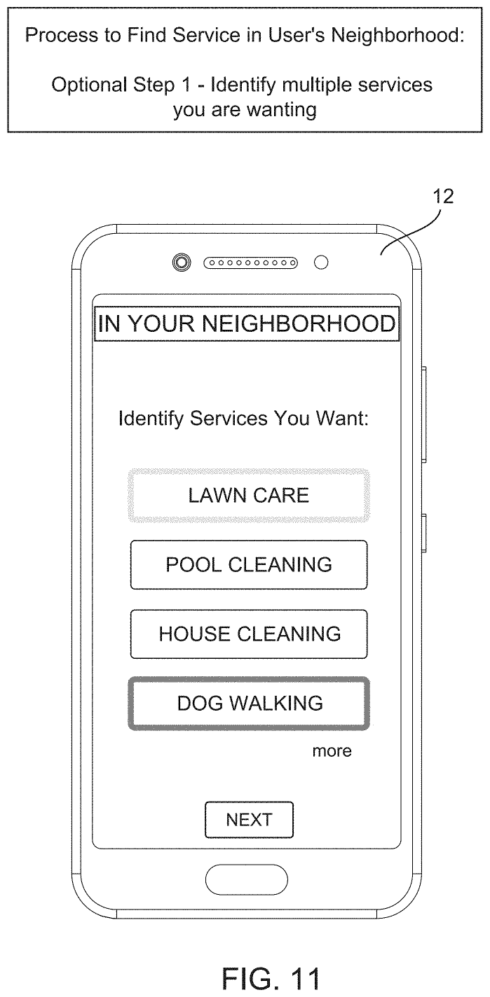

It will be understood that users may utilize the system to select multiple categories in a single search for services. As shown in FIG. 11, a user may select more than one service category, such as lawn care and dog walking. The server 14, once it receives and processes the selected categories, may send for display on the user computing device 12, a map with all differentiated identifiers between services, such as different colors. This is depicted as yellow for lawn care providers and blue for dog walkers. As can be seen some homes/addresses include both selected services and are so identified with both colors.

Embodiments may be available on or through the internet, such as through domain names reserved and owned by Applicant that include frontyardservice.com, niceyardneighbor.com, neighbor-neighbor.com, neighborhood-advice.com, monthlychores.com, nice-yard.com, neighborly-advice.com and the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A service provider marketing system comprising:
a server having a memory storing service provider information;
a provider computing device coupled to the server; and
a user computing device coupled to the server, wherein the server is programmed to:
receive and process a signal that the provider computing device has accessed the system for entering service provider information;
receive and store first service provider information sent from the user computing device in the memory of the server, wherein the first service provider information includes one or more service addresses, a first service category, and contact information for the first service provider;
receive and process a signal that the user computing device has accessed the system and is searching for service providers;
automatically send, for display, a user interface comprising selectable service categories, including the first service category;
receive and process a selection of the first service category from the user computing device;
automatically send, for display on the user computing device, a user interface comprising input of an address of a first service location that the user likes corresponding the first service category;
receive and process the first service location information sent from the user computing device, wherein the first service location information corresponds to the first service provider information; and
automatically send, for display on the user computing device, a user interface comprising the first service provider.

2. The system of claim 1, wherein the server is further programmed to send for display, in response to input from the user computing device, a view of all nearby addresses serviced by the first service provider.

3. The system of claim 2, where the view of all nearby addresses serviced by the first service provider is a map with designators for all nearby addresses serviced by the first service provider.

4. The system of claim 1, wherein the server is further programmed to send for display, in response to input from the user computing device, a view of all nearby addresses receiving services in the first service category and corresponding service providers for each address.

5. The system of claim 4, where the view of all nearby addresses receiving services in the first service category is a map with different designators on the nearby addresses, wherein each different designator corresponds to a different service provider.

6. The system of claim 1, wherein the server is further programmed to receive a request to contact the first service provider and automatically process and send for display on the user computing device, contact information for the first service provider.

7. The system of claim 1, wherein prior to receiving and storing the first service provider information, the server is programmed to send for display on the provider computing device a map wherein the first service provider provides services addresses by selecting buildings associated with the service addresses.
